(19) United States
(12) Patent Application Publication
(10) Pub. No.: US 2005/0200984 A1
(43) Pub. Date: Sep. 15, 2005

(54) Active mirror assemblies

(76) Inventors: Alan L. Browne, Grosse Pointe, MI (US); Jan H. Aase, Oakland Township, MI (US); Nancy L. Johnson, Northville, MI (US); James C. O'Kane, Shelby TWP, MI (US); Chandra S. Namuduri, Troy, MI (US); Andrew C. Keefe, Santa Monica, CA (US)

Correspondence Address: KATHRYN A MARRA;General Motors Corporation, Legal Staff, Mail Code 482-C23-B21, P.O. Box 300, Detroit, MI, 48265-3000, US

(21) Appl. No.: 11/078,644

(22) Filed: Mar. 11, 2005

Related U.S. Application Data
(60) Provisional application No. 60/552,758, filed on Mar. 12, 2004.

(51) Int. Cl. G02F 1/153

(52) U.S. Cl. 359/846; 359/872

(57) ABSTRACT

A mirror assembly includes a reflective surface disposed on a substrate; an actuator in operative communication with at least a portion of the substrate, wherein the actuator comprises an active material; and a controller in operative communication with the active material, wherein the controller is operable to selectively apply an activation signal to the active material and effect a change in a property of the active material, wherein the change in the property results in movement of the at least the portion of the substrate from a first position to a second position.

### CROSS REFERENCE TO RELATED APPLICATIONS

The present application relates to, and claims priority to, U.S. Provisional Application Ser. No. 60/552,758, which was filed on Mar. 12, 2004 and is incorporated herein in its entirety.

### BACKGROUND

This disclosure relates generally to mirrors and in particular to mirror assemblies incorporating active materials.

Motor vehicles commonly include mirrors with which the vehicle driver can view the conditions to the sides and/or rear of the vehicle within certain fields of view as dictated by the positioning of the mirrors. The position of these mirrors can be adjusted either manually (e.g., by means of a ball-and-socket pivoting mechanism), or automatically (e.g., using a mechanical or electro-mechanical remote joystick controller). While a mirror assembly incorporating automatic positional adjustment means may be more convenient, less labor intensive, and more precise in positional control, an actuator is necessary to permit movement of the mirror. Current actuators may have high part counts, loud motors, complex circuitry, and may be expensive to fabricate.

There accordingly remains a need in the art for new and improved mirror assemblies. It would be particularly desirable if these mirror assemblies provided the advantages of automatic mirror assemblies over their manual counterparts while simultaneously offering performance advantages (e.g., fewer parts, quieter, simpler in design, and/or less expensive to manufacture) over existing automatic mirror assemblies.

Regardless of how the position of a vehicle mirror(s) is adjusted, if the vehicle driver relies exclusively on the vehicle mirror(s) for providing a view of the conditions to the side and/or rear of the vehicle, the vehicle driver's view may be limited by blind spots. To compensate for a lack of knowledge as to the conditions of a particular blind spot, vehicle drivers often rotate their heads to briefly look into the blind spot. By doing so, the vehicle driver not only effectively diminishes the purpose of the mirror(s), but also temporarily loses sight of the conditions in front of the vehicle. Numerous solutions to this problem have been proposed. These include the addition of a relatively small convex mirror onto the surface of a currently existing mirror, placement of an extension arm between the mirror and its original mounting point, and incorporation of a turn signal indicator into the mirror surface or mirror assembly, among others. Unfortunately, each of these proposed solutions suffers from drawbacks. For example, an “add-on” convex mirror reduces the field of view of the mirror to which it is attached and, furthermore, the distance of objects seen in the “add-on” convex mirror cannot always be readily or accurately determined. Mirror extension arms find utility in a limited number situations, such as when the vehicle driver needs an extended rear and/or side view to see around a wide trailer or similar object. Finally, auxiliary turn signal indicators that are incorporated into mirror surfaces or mirror assemblies are only effective to alert others as to the intentions of the vehicle driver and do not assist the vehicle driver in seeing into blind spots.

Therefore, new and improved mirror assemblies, such as those contemplated above, would be further advantageous if, through their use, blind spots could be reduced in size or even eliminated.

### BRIEF SUMMARY

A mirror assembly includes a reflective surface disposed on a substrate; an actuator in operative communication with at least a portion of the substrate, wherein the actuator comprises an active material; and a controller in operative communication with the active material, wherein the controller is operable to selectively apply an activation signal to the active material and effect a change in a property of the active material, wherein the change in the property results in movement of the at least the portion of the substrate from a first position to a second position.

In another aspect, the mirror assembly includes a reflective surface disposed on a substrate, wherein the substrate comprises an active material; and a controller in operative communication with the active material, wherein the controller is operable to selectively apply an activation signal to the active material and effect a change in a property of the active material, wherein the change in the property results in a shape change of the substrate from a first shape to a second shape.

A method comprises providing a reflective surface in a first position and/or a first shape; applying an activation signal to an active material and causing a change in a property of the active material, wherein the active material is in operative communication with at least a portion of a substrate onto which the reflective surface is disposed; and changing a position and/or shape of the reflective surface by the change in the property of the active material effective to move the reflective surface from the first position and/or first shape to a selected second position and/or second shape.

The above described and other features are exemplified by the following figures and detailed description.

### BRIEF DESCRIPTION OF THE DRAWINGS

Referring now to the figures, which are exemplary embodiments and wherein like elements are numbered alike:

FIG. 1 schematically illustrates an active mirror assembly according to one embodiment;

FIG. 2 schematically illustrates mirror assemblies, having flexible substrates, in various shapes; and

FIG. 3 schematically illustrates mirror assemblies, comprising active material based substrates, in various shapes.

### DETAILED DESCRIPTION

Disclosed herein are mirror assemblies, and methods of use, which, in contrast to the prior art, are based on active materials to selectively adjust a position and/or shape of a reflective surface to control the focal point of reflected light. Although reference will be made herein to motor vehicle applications, it is contemplated that the active mirror assemblies can be employed in any situation which calls for positional and/or shape control of a mirror (i.e. to control light reflection), such as in cameras, lasers, telescopes, solar cells, microscopes, interferometry equipment, other optical or imaging instrumentation, and the like. For motor vehicle applications, the active mirror surfaces and active mirror assemblies can be utilized in side and/or rear view mirrors.

As used herein, the terms “first”, “second”, and the like do not denote any order or importance, but rather are used to distinguish one element from another; and the terms “the”, “a”, and “an” do not denote a limitation of quantity, but rather denote the presence of at least one of the referenced item. Directional descriptors used herein are with reference to the motor vehicle. Furthermore, all ranges disclosed herein are inclusive of the endpoints and independently combinable.

The term “active material” as used herein generally refers to a material that exhibits a change in a property such as dimension, shape, viscosity, and/or elastic modulus when subjected to an activation signal, examples of such signals being thermal, electrical, magnetic, mechanical, pneumatic, and the like. A first class of active materials comprises shape memory materials. These materials exhibit a shape memory effect. Specifically, after being deformed pseudoplastically, they can be restored to their original shape in response to the activation signal. Suitable shape memory materials include, without limitation, shape memory alloys (SMAs), ferromagnetic SMAs, and shape memory polymers (SMPs). A second class of active materials can be considered as those that exhibit a change in at least one attribute when subjected to an applied activation signal but revert back to their original state upon removal of the applied activation signal. Active materials in this category include, but are not limited to, piezoelectric materials, electroactive polymers (EAPs), dielectric polymers, magnetorheological fluids and elastomers (MR), electrorheological fluids (ER), composites of one or more of the foregoing materials with non-active materials such as ionic polymer metal composites (IPMCs), combinations comprising at least one of the foregoing materials, and the like.

The activation signal and its duration are dependent on the type, composition, and/or configuration of the active material. For example, a magnetic and/or an electrical signal may be applied for changing the property of the active material fabricated from magnetostrictive materials. A thermal signal may be applied for changing the property of the active material fabricated from shape memory alloys and/or shape memory polymers. An electrical signal may be applied for changing the property of the active material fabricated from EAPs, piezoelectrics, and/or IPMCs.

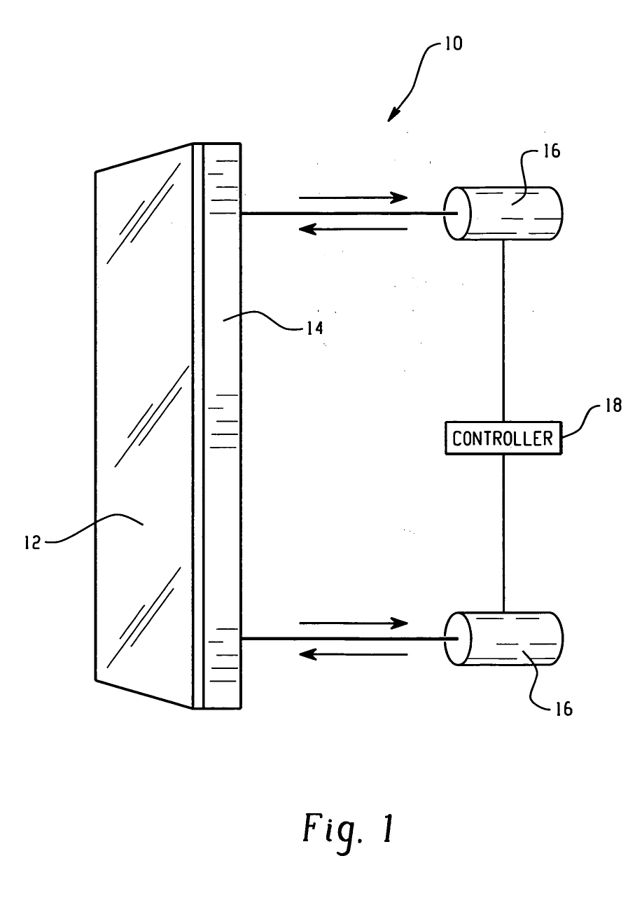

FIG. 1 illustrates one embodiment of an active mirror assembly 10. The mirror assembly 10 generally includes a reflective surface 12 disposed on a substrate 14. An (i.e., at least one) actuator 16 comprising an active material (not shown) is in operative communication with at least a portion of the substrate 14. The active material is in operative communication with a controller 18. In this manner, producing the activation signal with the controller 18 effects the change in the property of the active material, which allows the actuator 16 to adjust the position (i.e., planar orientation) of at least the portion of the substrate 14 such that the reflective surface 12 moves from a first position to a second position.

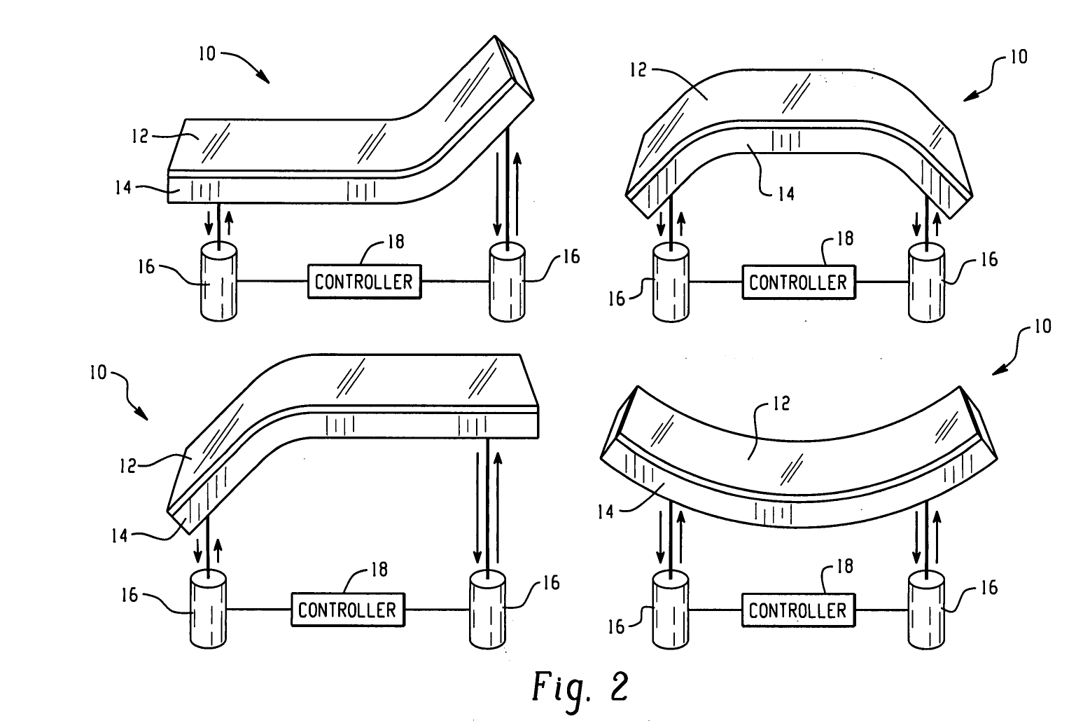

Optionally, the substrate 14 is formed from a non-active, but flexible material, such that the reflective surface 12 is disposed on the flexible material. In this manner, producing the activation signal with the controller 18 effects the change in the property of the active material, which allows the actuator 16 to adjust the shape of at least the portion of the substrate (flexible material) 14, and consequently the reflective surface 12, from a first shape to a second shape. The shape change of the substrate may comprise the flexible material bending or bowing at a so called “flex point”. FIG. 2 illustrates some of the various shapes that this type of mirror assembly 10 may adopt when the substrate 14 is formed from a flexible material to enable focal point control. For example the mirror assembly 10 may have a concave, convex, pseudo-concave, or pseudo-convex shape, among others.

In an exemplary embodiment, the actuator 16 has a linear mechanical response to the activation signal. Suitable linear mechanical actuators 16 can be formed of SMAs, ferromagnetic SMAs, SMPs, EAPs, piezoelectrics, IPMCs, or combinations comprising at least one of the foregoing active materials. For example, an SMA actuator 16 may be in the form of a spring, wire, ribbon, or similar form that has a mechanical response upon the application and/or removal of heat, such as Joule heating or air convection. These types of actuators can provide displacement or induce a force when heated up in constant load or constant deflection conditions, respectively. It may be desirable to have a plurality of actuators to provide the movement desired. In one embodiment, actuators 16 are provided in pairs or in opposition to a biasing means to cause an opposed movement. In another embodiment, actuators 16 comprise different active materials to provide a zero-power hold of the shape and/or position of the reflective surface 12. For example, MR and ER fluids, whose shear strength is directly controlled by the strength of an applied field, can be used in a damper to hold the second reflective surface 12 shape and/or position achieved through the actuator 16, after discontinuation of the activation sign al to the actuator 16.

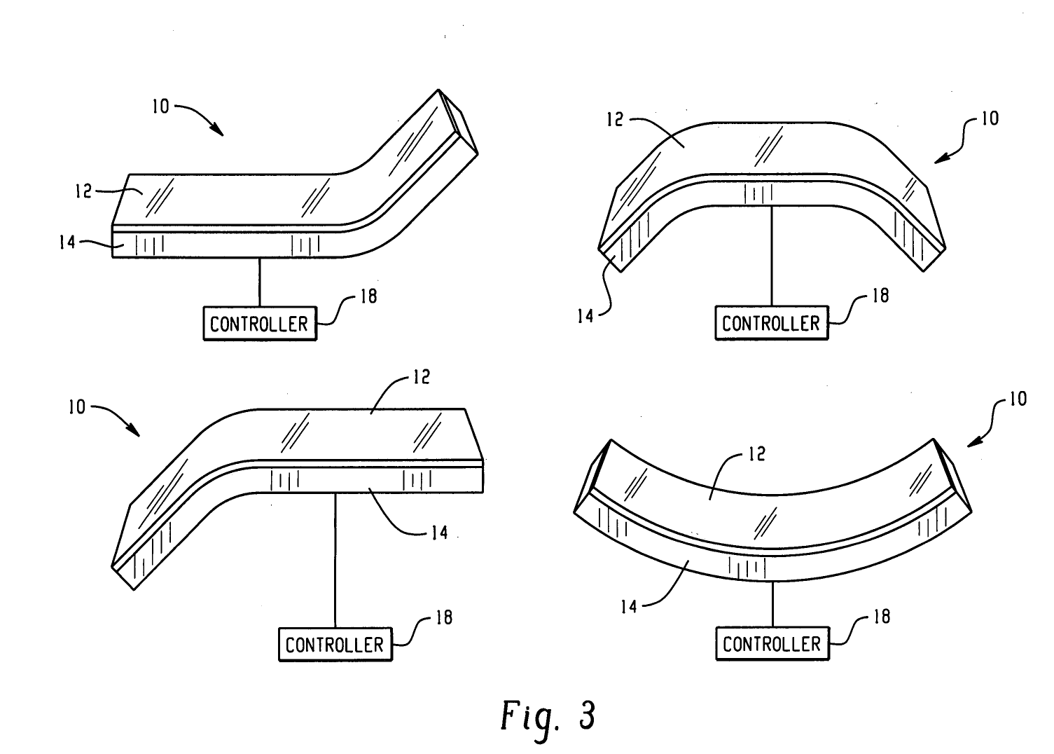

In another embodiment of the active mirror assembly 10, the substrate 14 comprises the active material, and the actuator 16 is optional. For example, the substrate may be formed from a layer of a SMA, a piezoelectric, EAP, or the like, and may take the form of a sheet or laminated sheet. The controller 18 is in operative communication with the active material of the substrate 14 (and, optionally, the actuator 16). In this manner, producing the activation signal with the controller 18 effects the change in the property of the active material, which allows the substrate 14 to adjust its shape from a first shape to a second shape. FIG. 3 illustrates some of the various shapes that this type of mirror assembly 10 may adopt, to enable focal point control, when the substrate comprises the active material. For example the mirror assembly 10 may have a concave, convex, pseudo-concave, or pseudo-convex shape, among others.

The illustrated mirror assemblies 10 are exemplary only and are not intended to be limited to any particular shape, size, configuration, or the like. For example, the reflective surface 12 and substrate 14 may be disposed within a housing (not shown) that further provides a means for housing the actuator 16 and routing the communication means between the various components. Furthermore, the mirror assembly 10 may include a sensor (not shown) in operative communication with the controller. The sensor may be adapted to provide information to the controller for selectively applying the activation signal to effect the change in the shape and/or position of the reflective surface 12.

The mirror assemblies disclosed herein may function in numerous ways, a few of which are described hereinbelow. Other functions and/or uses will be readily recognized by those skilled in the art in view of this disclosure.

In one embodiment, the position of the reflective surface of a side view mirror assembly can be adjusted each time a new vehicle driver operates the vehicle using, for example, a joystick controller. The joystick controller may activate a shape memory material (e.g., SMA, SMP, ferromagnetic SMA, and the like) actuator to move the reflective surface into a position as desired by the vehicle driver. Furthermore, if the particular vehicle is equipped with a positional memory function for the mirror assembly, the desired position of the reflective surface may be set into memory using the shape memory effect of the shape memory material. The memorized position of the reflective surface may be accessed at any time by activating the actuator, to its corresponding set or trained shape with the controller, such as by depressing a memory button or using a remote key fob that is indicative of the vehicle driver. In a similar fashion, the position of the reflective surface of a rear view mirror assembly may be memorized, and the memorized position accessed, using a shape memory material.

In another embodiment, a rear view mirror assembly comprises a sensor that detects an intensity of light (e.g., from a head and/or fog lamp of a rearward vehicle, the sun, a billboard illumination, a spotlight, and the like), and based on the intensity of light detected may change the position and/or shape of the reflective surface to decrease an amount of such light reflected into the vehicle driver's eyes. In operation, the actuator and/or the substrate, which may comprise a shape memory material, piezoelectric material, EAP, or IPMC, is activated to change the position and/or shape of the reflective surface upon detection of an intensity of light that may be undesirable for the vehicle driver. This position and/or shape change is maintained for a period of time until the intensity of the light detected by the sensor drops below a selected level, at which time the position and/or shape of the reflective surface returns to the first position and/or shape. A similar light intensity reducing position and/or shape change may be implemented in a side view mirror assembly.

Another function for a side view mirror assembly includes a positional and/or shape change to minimize a blind spot during reverse motion of the vehicle. When the vehicle is shifted into reverse, the reflective surface may be configured to tilt downward to provide the vehicle driver with a view of a curb or other such low-lying (i.e., tire-level) rearward obstruction. The actuator may comprise a piezoelectric material, EAP, IPMC, or the like, that is activated to tilt the reflective surface immediately upon the vehicle being shifted into reverse. Once the vehicle is shifted out of reverse, the activation signal is discontinued, the change in the property of the active material is no longer effected, and the reflective surface returns to its first position. Alternatively, instead of changing the position of the reflective surface to tilt downward, the shape of the reflective surface may become, for example, concave or pseudo-concave such that an upper portion of the reflective surface provides the vehicle driver with a downward view while a lower portion of the reflective surface provides the driver with an eye-level rearward view. In this manner, the vehicle driver not only can see the curb or other low-lying rearward obstruction, but can still maintain the original field of vision.

In another embodiment, a side view mirror assembly is configured to undergo a positional and/or shape change to minimize a blind spot upon indication that the vehicle is about to change direction. Such indication can include a use of a turn signal, a rotation or the steering wheel, or the like. Upon the indication that the vehicle is turning left (or right), the reflective surface of the left (or right), side view mirror assembly may tilt outward to provide the vehicle driver with a increased field of view. The actuator may comprise a piezoelectric material, EAP, IPMC, or the like, that is activated to tilt the reflective surface immediately upon the directional change indication. Once the vehicle has completed the change of direction (e.g., when the turn signal has been deactivated, the steering wheel is no longer rotated in any direction, or the like), the activation signal is discontinued, the change in the property of the active material is no longer effected, and the reflective surface returns to its first position. Alternatively, instead of changing the position of the reflective surface to tilt outward, the shape of the reflective surface may become, for example, convex or pseudo-convex such that an outer portion of the reflective surface provides the vehicle driver with an outward view while an inner portion of the reflective surface provides the driver with the normal sideward view. In this manner, the vehicle driver not only maintains the original field of vision, but can also see into a blind spot.

Instead of, or in addition to, sensing that the vehicle is about to change direction, the side view mirror assembly may comprise a motion and/or distance sensor configured to detect another vehicle within a blind spot. In this manner, the reflective surface may undergo the positional and/or shape change preemptively to inform the vehicle driver of the conditions surrounding the vehicle. The extent to which the positional and/or shape change in the reflective surface occurs may be dictated by the speed at which the vehicle is traveling, by the extent to which the wheel is rotated during the directional change, by the distance and/or velocity of a vehicle in the blind spot, as desired by the vehicle driver, or the like.

In yet another embodiment, buildup such as ice, snow, rain, or the like, that has accumulated on the reflective surface of a side view mirror assembly may be removed by having the reflective surface undergo a vibratory shape change. For example, the substrate may be fabricated from a piezoelectric, EAP, IPMC or the like, such that the reflective surface disposed on the active substrate continuously and repeatedly changes from concave to convex for a selected period of time or as long as desired by the vehicle driver. Desirably, these vibrations occur at a frequency sufficient to remove the buildup with minimal loss of field of view by the vehicle driver.

As previously described, suitable active materials include, without limitation, shape memory alloys (SMAs), ferromagnetic SMAs, shape memory polymers (SMPs), piezoelectric materials, electroactive polymers (EAPs), magnetorheological fluids and elastomers (MR), electrorheological fluids and elastomers (ER), composites of one or more of the foregoing materials with non-active materials such as ionic polymer metal composites (IPMCs), combinations comprising at least one of the foregoing materials, and the like

Suitable shape memory alloys can exhibit a one-way shape memory effect, an intrinsic two-way effect, or an extrinsic two-way shape memory effect depending on the alloy composition and processing history. The two most commonly utilized phases that occur in shape memory alloys are often referred to as martensite and austenite phases. In the following discussion, the martensite phase generally refers to the more deformable, lower temperature phase whereas the austenite phase generally refers to the more rigid, higher temperature phase. When the shape memory alloy is in the martensite phase and is heated, it begins to change into the austenite phase. The temperature at which this phenomenon starts is often referred to as austenite start temperature (As). The temperature at which this phenomenon is complete is called the austenite finish temperature (Af). When the shape memory alloy is in the austenite phase and is cooled, it begins to change into the martensite phase, and the temperature at which this phenomenon starts is referred to as the martensite start temperature (Ms). The temperature at which austenite finishes transforming to martensite is called the martensite finish temperature (Mf). Generally, the shape memory alloys are softer and more easily deformable in their martensitic phase and are harder, stiffer, and/or more rigid in the austenitic phase. Thus, a suitable activation signal for use with shape memory alloys is a thermal activation signal having a magnitude to cause transformations between the martensite and austenite phases.

The temperature at which the shape memory alloy remembers its high temperature form when heated can be adjusted by slight changes in the composition of the alloy and through heat treatment. In nickel-titanium shape memory alloys, for instance, it can be changed from above about 100° C. to below about −100° C. The shape recovery process occurs over a range of just a few degrees and the start or finish of the transformation can be controlled to within a degree or two depending on the desired application and alloy composition. The mechanical properties of the shape memory alloy vary greatly over the temperature range spanning their transformation, typically providing shape memory effects, superelastic effects, and high damping capacity.

Suitable shape memory alloy materials include, but are not intended to be limited to, nickel-titanium based alloys, indium-titanium based alloys, nickel-aluminum based alloys, nickel-gallium based alloys, copper based alloys (e.g., copper-zinc alloys, copper-aluminum alloys, copper-gold, and copper-tin alloys), gold-cadmium based alloys, silver-cadmium based alloys, indium-cadmium based alloys, manganese-copper based alloys, iron-platinum based alloys, iron-palladium based alloys, and the like. The alloys can be binary, ternary, or any higher order so long as the alloy composition exhibits a shape memory effect, e.g., change in shape orientation, changes in yield strength, and/or elastic modulus properties, damping capacity, superelasticity, and the like. Selection of a suitable shape memory alloy composition depends on the temperature range where the component will operate.

Shape memory polymers (SMPs) generally refer to a group of polymeric materials that exhibit a change in a property, such as an elastic modulus, a shape, a dimension, a shape orientation, or a combination comprising at least one of the foregoing properties upon application of a thermal activation signal. Generally, SMPs are phase segregated co-polymers comprising at least two different units, which may be described as defining different segments within the SMP, each segment contributing differently to the overall properties of the SMP. As used herein, the term “segment” refers to a block, graft, or sequence of the same or similar monomer or oligomer units, which are copolymerized to form the SMP. Each segment may be crystalline or amorphous and will have a corresponding melting point or glass transition temperature (Tg), respectively. The term “thermal transition temperature” is used herein for convenience to generically refer to either a Tg or a melting point depending on whether the segment is an amorphous segment or a crystalline segment. For SMPs comprising (n) segments, the SMP is said to have a hard segment and (n-1) soft segments, wherein the hard segment has a higher thermal transition temperature than any soft segment. Thus, the SMP has (n) thermal transition temperatures. The thermal transition temperature of the hard segment is termed the “last transition temperature”, and the lowest thermal transition temperature of the so-called “softest” segment is termed the “first transition temperature”. It is important to note that if the SMP has multiple segments characterized by the same thermal transition temperature, which is also the last transition temperature, then the SMP is said to have multiple hard segments.

When the SMP is heated above the last transition temperature, the SMP material can be shaped. A permanent shape for the SMP can be set or memorized,by subsequently cooling the SMP below that temperature. As used herein, the terms “original shape”, “previously defined shape”, and “permanent shape” are synonymous and are intended to be used interchangeably. A temporary shape can be set by heating the material to a temperature higher than a thermal transition temperature of any soft segment yet below the last transition temperature, applying an external stress or load to deform the SMP, and then cooling below the particular thermal transition temperature of the soft segment.

The permanent shape can be recovered by heating the material, with the stress or load removed, above the particular thermal transition temperature of the soft segment yet below the last transition temperature. Thus, it should be clear that by combining multiple soft segments it is possible to demonstrate multiple temporary shapes and with multiple hard segments it may be possible to demonstrate multiple permanent shapes. Similarly using a layered or composite approach, a combination of multiple SMPs will demonstrate transitions between multiple temporary and permanent shapes.

For SMPs with only two segments, the temporary shape of the shape memory polymer is set at the first transition temperature, followed by cooling of the SMP, while under load, to lock in the temporary shape. The temporary shape is maintained as long as the SMP remains below the first transition temperature. The permanent shape is regained when the SMP is once again brought above the first transition temperature. Repeating the heating, shaping, and cooling steps can repeatedly reset the temporary shape.

Most SMPs exhibit a “one-way” effect, wherein the SMP exhibits one permanent shape. Upon heating the shape memory polymer above a soft segment thermal transition temperature without a stress or load, the permanent shape is achieved and the shape will not revert back to the temporary shape without the use of outside forces.

As an alternative, some shape memory polymer compositions can be prepared to exhibit a “two-way” effect, wherein the SMP exhibits two permanent shapes. These systems include at least two polymer components. For example, one component could be a first cross-linked polymer while the other component is a different cross-linked polymer. The components are combined by layer techniques, or are interpenetrating networks, wherein the two polymer components are cross-linked but not to each other. By changing the temperature, the shape memory polymer changes its shape in the direction of a first permanent shape or a second permanent shape. Each of the permanent shapes belongs to one component of the SMP. The temperature dependence of the overall shape is caused by the fact that the mechanical properties of one component (“component A”) are almost independent from the temperature in the temperature interval of interest. The mechanical properties of the other component (“component B”) are temperature dependent in the temperature. interval of interest. In one embodiment, component B becomes stronger at low temperatures compared to component A, while component A is stronger at high, temperatures and determines the actual shape. A two-way memory device can be prepared by setting the permanent shape of component A (“first permanent shape”), deforming the device into the permanent shape of component B (“second permanent shape”), and fixing the permanent shape of component B while applying a stress.

It should be recognized by one of ordinary skill in the art that it is possible to configure SMPs in many different forms and shapes. Engineering the composition and structure of the polymer itself can allow for the choice of a particular temperature for a desired application. For example, depending on the particular application, the last transition temperature may be about 0° C. to about 300° C. or above. A temperature for shape recovery (i.e., a soft segment thermal transition temperature) may be greater than or equal to about −30° C. Another temperature for shape recovery may be greater than or equal to about 40° C. Another temperature for shape recovery may be greater than or equal to about 70° C. Another temperature for shape recovery may be less than or equal to about 250° C. Yet another temperature for shape recovery may be less than or equal to about 200° C. Finally, another temperature for shape recovery may be less than or equal to about 150° C.

Suitable polymers for use in the SMPs include thermoplastics, thermosets, interpenetrating networks, semi-interpenetrating networks, or mixed networks of polymers. The polymers can be a single polymer or a blend of polymers. The polymers can be linear or branched thermoplastic elastomers with side chains or dendritic structural elements. Suitable polymer components to form a shape memory polymer include, but are not limited to, polyphosphazenes, poly(vinyl alcohols), polyamides, polyester amides, poly(amino acid)s, polyanhydrides, polycarbonates, polyacrylates, polyalkylenes, polyacrylamides, polyalkylene glycols, polyalkylene oxides, polyalkylene terephthalates, polyortho esters, polyvinyl ethers, polyvinyl esters, polyvinyl halides, polyesters, polylactides, polyglycolides, polysiloxanes, polyurethanes, polyethers, polyether amides, polyether esters, polystyrene, polypropylene, polyvinyl phenol, polyvinylpyrrolidone, chlorinated polybutylene, poly(octadecyl vinyl ether)ethylene vinyl acetate, polyethylene, poly(ethylene oxide)-poly(ethylene terephthalate), polyethylene/nylon (graft copolymer), polycaprolactones-polyamide (block copolymer), poly(caprolactone)dimethacrylate-n-butyl acrylate, poly(norbornyl-polyhedral oligomeric silsesquioxane), polyvinyl chloride, urethane/butadiene copolymers, polyurethane block copolymers, styrene-butadiene-styrene block copolymers, and the like, and combinations comprising at least one of the foregoing polymer components. Examples of suitable polyacrylates include poly(methyl methacrylate), poly(ethyl methacrylate), ply(butyl methacrylate), poly(isobutyl methacrylate), poly(hexyl methacrylate), poly(isodecyl methacrylate), poly(lauryl methacrylate), poly(phenyl methacrylate), poly(methyl acrylate), poly(isopropyl acrylate), poly(isobutyl acrylate) and poly(octadecyl acrylate). The polymer(s) used to form the various segments in the SMPs described above are either commercially available or can be synthesized using routine chemistry. Those of skill in the art can readily prepare the polymers using known chemistry and processing techniques without undue experimentation.

The shape memory polymer or the shape memory alloy, may be activated by any suitable means, preferably a means for subjecting the material to a temperature change above, or below, a transition temperature. For example, for elevated temperatures, heat may be supplied using hot gas (e.g., air), steam, hot liquid, or electrical current. The activation means may, for example, be in the form of heat conduction from a heated element in contact with the shape memory material, heat convection from a heated conduit in proximity to the thermally active shape memory material, a hot air blower or jet, microwave interaction, resistive heating, and the like. In the case of a temperature drop, heat may be extracted by thermoelectric cooling, using a cold gas, or evaporation of a refrigerant. The activation means may, for example, be in the form of a cool room or enclosure, a cooling probe having a cooled tip, a control signal to a thermoelectric unit, a cold air blower or jet, or means for introducing a refrigerant (such as liquid nitrogen) to at least the vicinity of the shape memory material.

Suitable magnetic materials for use in magnetic SMAs include, but are not intended to be limited to, soft or hard magnets; hematite; magnetite; magnetic material based on iron, nickel, and cobalt, alloys of the foregoing, or combinations comprising at least one of the foregoing, and the like. Alloys of iron, nickel and/or cobalt, can comprise aluminum, silicon, cobalt, nickel, vanadium, molybdenum, chromium, tungsten, manganese and/or copper.

As used herein, the term “piezoelectric” is used to describe a material that mechanically deforms (changes shape) when a voltage potential is applied, or conversely, generates an electrical charge when mechanically deformed. Employing the piezoelectric material will utilize an electrical signal for activation. Upon activation, the piezoelectric material can cause displacement in the powered state. Upon discontinuation of the activation signal, the strips will assume its original shape orientation.

Preferably, a piezoelectric material is disposed on strips of a flexible metal or ceramic sheet. The strips can be unimorph or bimorph. Preferably, the strips are bimorph, because bimorphs generally exhibit more displacement than unimorphs.

One type of unimorph is a structure composed of a single piezoelectric element externally bonded to a flexible metal foil or strip, which is stimulated by the piezoelectric element when activated with a changing voltage and results in an axial buckling or deflection as it opposes the movement of the piezoelectric element. The actuator movement for a unimorph can be by contraction or expansion.

In contrast to the unimorph piezoelectric device, a bimorph device includes an intermediate flexible metal foil sandwiched between two piezoelectric elements. Bimorphs exhibit more displacement than unimorphs because under the applied voltage one ceramic element will contract while the other expands.

Suitable piezoelectric materials include inorganic compounds, organic compounds, and metals. With regard to organic materials, all of the polymeric materials with non-centrosymmetric structure and large dipole moment group(s) on the main chain or on the side-chain, or on both chains within the molecules, can be used as candidates for the piezoelectric film. Examples of suitable polymers include, for example, but are not limited to, poly(sodium 4-styrenesulfonate) (“PSS”), poly S-119 (poly(vinylamine)backbone azo chromophore), and their derivatives; polyfluorocarbons, including polyvinylidene fluoride (“PVDF”), its co-polymer vinylidene fluoride (“VDF”), trifluoroethylene (TrFE), and their derivatives; polychlorocarbons, including poly(vinyl chloride) (“PVC”), polyvinylidene chloride (“PVDC”), and their derivatives; polyacrylonitriles (“PAN”), and their derivatives; polycarboxylic acids, including poly(methacrylic acid (“PMA”), and their derivatives; polyureas, and their derivatives; polyurethanes (“PU”), and their derivatives; bio-polymer molecules such as poly-L-lactic acids and their derivatives, and membrane proteins, as well as phosphate bio-molecules; polyanilines and their derivatives, and all of the derivatives of tetramines; polyimides, including Kapton molecules and polyetherimide (“PEI”), and their derivatives; all of the membrane polymers; poly(N-vinyl pyrrolidone) (“PVP”) homopolymer, and its derivatives, and random PVP-co-vinyl acetate (“PVAc”) copolymers; and all of the aromatic polymers with dipole moment groups in the main-chain or side-chains, or in both the main-chain and the side-chains, and mixtures thereof.

Piezoelectric materials can also comprise metals such as lead, antimony, manganese, tantalum, zirconium, niobium, lanthanum, platinum, palladium, nickel, tungsten, aluminum, strontium, titanium, barium, calcium, chromium, silver, iron, silicon, copper, alloys comprising at least one of the foregoing metals, and oxides comprising at least one of the foregoing metals. Suitable metal oxides include SiO₂, Al₂O₃, ZrO₂, TiO₂, SrTiO₃, PbTiO₃, BaTiO₃, FeO₃, Fe₃o₄, ZnO, and mixtures thereof and Group VIA and IIB compounds, such as CdSe, CdS, GaAs, AgCaSe₂, ZnSe, GaP, InP, ZnS, and mixtures thereof. Specific desirable piezoelectric materials are polyvinylidene fluoride, lead zirconate titanate, and barium titanate.

Electroactive polymers include those polymeric materials that exhibit piezoelectric, pyroelectric, or electrostrictive properties in response to electrical or mechanical, fields. The materials generally employ the use of compliant electrodes that enable polymer films to expand or contract in the in-plane directions in response to applied electric fields or mechanical stresses. An example is an electrostrictive-grafted elastomer with a piezoelectric poly(vinylidene fluoride-trifluoro-ethylene)copolymer. This combination has the ability to produce a varied amount of ferroelectric-electrostrictive molecular composite systems. These may be operated as a piezoelectric sensor or even an electrostrictive actuator. Activation of an EAP based pad preferably utilizes an electrical signal to provide change in shape orientation sufficient to provide displacement. Reversing the polarity of the applied voltage to the EAP can provide shape reversibility.

Materials suitable for use as the electroactive polymer may include any substantially insulating polymer or rubber (or combination thereof) that deforms in response to an electrostatic force or whose deformation results in a change in electric field. Exemplary materials suitable for use as a pre-strained polymer include silicone elastomers, acrylic elastomers, polyurethanes, thermoplastic elastomers, copolymers comprising PVDF, pressure-sensitive adhesives, fluoroelastomers, polymers comprising silicone and acrylic moieties, and the like. Polymers comprising silicone and acrylic moieties may include copolymers comprising silicone and acrylic moieties, polymer blends comprising a silicone elastomer and an acrylic elastomer, for example.

Materials used as an electroactive polymer may be selected based on one or more material properties such as a high electrical breakdown strength, a low modulus of elasticity—(for large or small deformations), a high dielectric constant, and the like. In one embodiment, the polymer is selected such that is has an elastic modulus at most about 100 megaPascals (MPa). In another embodiment, the polymer is selected such that is has a maximum actuation pressure between about 0.05 MPa and about 10 MPa, and preferably between about 0.3 MPa and about 3 MPa. In another embodiment, the polymer is selected such that is has a dielectric constant between about 2 and about 20, and preferably between about 2.5 and about 12. The present disclosure is not intended to be limited to these ranges. Ideally, materials with a higher dielectric constant than the ranges given above would be desirable if the materials had both a high dielectric constant and a high dielectric strength. In many cases, electroactive polymers may be fabricated and implemented as thin films. Thicknesses suitable for these thin films may be below 50 micrometers.

As electroactive polymers may deflect at high strains, electrodes attached to the polymers should also deflect without compromising mechanical or electrical performance. Generally, electrodes suitable for use may be of any shape and material provided that they are able to supply a suitable voltage to, or receive a suitable voltage from, an electroactive polymer. The voltage may be either constant or varying over time. In one embodiment, the electrodes adhere to a surface of the polymer. Electrodes adhering to the polymer are preferably compliant and conform to the changing shape of the polymer. Correspondingly, the present disclosure may include compliant electrodes that conform to the shape of an electroactive polymer to which they are attached. The electrodes may be only applied to a portion of an electroactive polymer and define an active area according to their geometry. Various types of electrodes suitable for use with the present disclosure include structured electrodes comprising metal traces and charge distribution layers, textured electrodes comprising varying out of plane dimensions, conductive greases such as carbon greases or silver greases, colloidal suspensions, high aspect ratio conductive materials such as carbon fibrils and carbon nanotubes, and mixtures of ionically conductive materials.

Materials used for electrodes of the present disclosure may vary. Suitable materials used in an electrode may include graphite, carbon black, colloidal suspensions, thin metals including silver and gold, silver filled and carbon filled gels and polymers, and ionically or electronically conductive polymers. It is understood that certain electrode materials may work well with particular polymers and may not work as well for others. By way of example, carbon fibrils work well with acrylic elastomer polymers while not as well with silicone polymers.

Suitable MR fluid materials include, but are not intended to be limited to, ferromagnetic or paramagnetic particles dispersed in a carrier fluid. Suitable particles include iron; iron alloys, such as those including aluminum, silicon, cobalt, nickel, vanadium, molybdenum, chromium, tungsten, manganese and/or copper; iron oxides, including Fe₂O₃ and Fe₃O₄; iron nitride; iron carbide; carbonyl iron; nickel and alloys of nickel; cobalt and alloys of cobalt; chromium dioxide; stainless steel; silicon steel; and the like. Examples of suitable particles include straight iron powders, reduced iron powders, iron oxide powder/straight iron powder mixtures and iron oxide powder/reduced iron powder mixtures. A preferred magnetic-responsive particulate is carbonyl iron, preferably, reduced carbonyl iron.

The particle size should be selected so that the particles exhibit multi-domain characteristics when subjected to a magnetic field. Average dimension sizes for the particles can be less than or equal to about 1,000 micrometers, with less than or equal to about 500 micrometers preferred, and less than or equal to about 100 micrometers more preferred. Also preferred is a particle dimension of greater than or equal to about 0.1 micrometer, with greater than or equal to about 0.5 more preferred, and greater than or equal to about 10 micrometers especially preferred. The particles are preferably present in an amount between about 5.0 to about 50 percent by volume of the total MR fluid composition.

Suitable carrier fluids include organic liquids, especially non-polar organic liquids. Examples include, but are not limited to, silicone oils; mineral oils; paraffin oils; silicone copolymers; white oils; hydraulic oils; transformer oils; halogenated organic liquids, such as chlorinated hydrocarbons, halogenated paraffins, perfluorinated polyethers and fluorinated hydrocarbons; diesters; polyoxyalkylenes; fluorinated silicones; cyanoalkyl siloxanes; glycols; synthetic hydrocarbon oils, including both unsaturated and saturated; and combinations comprising at least one of the foregoing fluids.

The viscosity of the carrier component can be less than or equal to about 100,000 centipoise, with less than or equal to about 10,000 centipoise preferred, and less than or equal to about 1,000 centipoise more preferred. Also preferred is a viscosity of greater than or equal to about 1 centipoise, with greater than or equal to about 250 centipoise preferred, and greater than or equal to about 500 centipoise especially preferred.

Aqueous carrier fluids may also be used, especially those comprising hydrophilic mineral clays such as bentonite or hectorite. The aqueous carrier fluid may comprise water or water comprising a small amount of polar, water-miscible organic solvents such as methanol, ethanol, propanol, dimethyl sulfoxide, dimethyl formamide, ethylene carbonate, propylene carbonate, acetone, tetrahydrofuran, diethyl ether, ethylene glycol, propylene glycol, and the like. The amount of polar organic solvents is less than or equal to about 5.0% by volume of the total MR fluid, and preferably less than or equal to about 3.0%. Also, the amount of polar organic solvents is preferably greater than or equal to about 0.1%, and more preferably greater than or equal to about 1.0% by volume of the total MR fluid. The pH of the aqueous carrier fluid is preferably less than or equal to about 13, and preferably less than or equal to about 9.0. Also, the pH of the aqueous carrier fluid is greater than or equal to about 5.0, and preferably greater than or equal to about 8.0.

Natural or synthetic bentonite or hectorite may be used. The amount of bentonite or hectorite in the MR fluid is less than or equal to about 10 percent by weight of the total MR fluid, preferably less than or equal to about 8.0 percent by weight, and more preferably less than or equal to about 6.0 percent by weight. Preferably, the bentonite or hectorite is present in greater than or equal to about 0.1 percent by weight, more preferably greater than or equal to about 1.0 percent by weight, and especially preferred greater than or equal to about 2.0 percent by weight of the total MR fluid.

Optional components in the MR fluid include clays, organoclays, carboxylate soaps, dispersants, corrosion inhibitors, lubricants, extreme pressure anti-wear additives, antioxidants, thixotropic agents and conventional suspension agents. Carboxylate soaps include ferrous oleate, ferrous naphthenate, ferrous stearate, aluminum di- and tri-stearate, lithium stearate, calcium stearate, zinc stearate and sodium stearate, and surfactants such as sulfonates, phosphate esters, stearic acid, glycerol monooleate, sorbitan sesquioleate, laurates, fatty acids, fatty alcohols, fluoroaliphatic polymeric esters, and titanate, aluminate and zirconate coupling agents and the like. Polyalkylene diols, such as polyethylene glycol, and partially esterified polyols can also be included.

Suitable MR elastomer materials include, but are not intended to be limited to, an elastic polymer matrix comprising a suspension of ferromagnetic or paramagnetic particles, wherein the particles are described above. Suitable polymer matrices include, but are not limited to, poly-alpha-olefins, natural rubber, silicone, polybutadiene, polyethylene, polyisoprene, or other polymeric materials described herein.

Ionic polymer metal composites (IPMCs) are an example of a composite of an active material (e.g., electroactive ionic polymer) with a non-active material (e.g., metal). IPMCs generally show large deformation in the presence of low applied voltage and exhibit low impedance. As an example, an IPMC can comprise a solid polymeric electrolytic element sandwiched between a working electrode and a counter electrode. The solid polymer electrolyte material may be an ion-exchange resin such as, for example, a hydrocarbon- or a fluorocarbon-type resin, or any of the electroactive polymeric materials described herein. Preferably, the solid polymer electrolyte material is a fluorocarbon-type ion-exchange resin having sulfonic, carboxylic, and/or phosphoric acid functionality. Fluorocarbon-type ion-exchange resins may include hydrates of a tetrafluoroethylene-perfluorosulfonyl ethoxyvinyl ether or tetra fluoroethylene-hydroxylated(perfluoro vinyl ether)copolymers. Such resins typically exhibit excellent resistance to oxidation induced by contact with halogens, strong acids, and bases.

Both the working electrode and counter electrode may comprise sheets of material through which an electrical charge can be distributed. Materials from which the electrodes can be fabricated include, but are not limited to, platinum, palladium, rhodium, iridium, ruthenium osmium, carbon, gold, tantalum, tin, indium, nickel, tungsten, manganese, and the like, as well as mixtures, oxides, alloys, any of the other electrode materials described herein, and combinations comprising at least one of the foregoing materials. Preferably, the electrodes comprise platinum.

Advantageously, the above noted mirror assemblies utilizing the active materials described herein do not require motors and/or gears. Since motors are not necessarily utilized, the shape and/or position adjustment mechanism can be compact, low cost, quiet, and/or lightweight. Furthermore, it should be recognized by those skilled in the art that these mirror assemblies diminish the size of, or eliminate, blind spots with their focal point control mechanisms. It should also be recognized that the mirror assemblies, as described herein, can be configured to optionally include any of the myriad convenience features found in existing mirror assemblies such as a heating device, turn signal indicator, puddle lamp, electrochromic or other light dimmer, temperature and/or compass display, speaker, microphone, and voice recording device, among others.

While the disclosure has been described with reference to exemplary embodiments, it will be understood by those skilled in the art that various changes may be made and equivalents may be substituted for elements thereof without departing from the scope of the disclosure. In addition, many modifications may be made to adapt a particular situation or material to the teachings of the disclosure without departing from the essential scope thereof. Therefore, it is intended that the disclosure not be limited to the particular embodiment disclosed as the best mode contemplated for carrying out this disclosure, but that the disclosure will include all embodiments falling within the scope of the appended claims.

1. A mirror assembly, comprising:
a reflective surface disposed on a substrate;
an actuator in operative communication with at least a portion of the substrate, wherein the actuator comprises an active material; and
a controller in operative communication with the active material, wherein the controller is operable to selectively apply an activation signal to the active material and effect a change in a property of the active material, wherein the change in the property results in movement of the at least the portion of the substrate from a first position to a second position.

2. The mirror assembly of claim 1, wherein the substrate comprises a non-active, flexible material configured to undergo a shape change from a first shape to a second shape upon application of the activation signal to the active material.

3. The mirror assembly of claim 1, wherein the active material comprises a shape memory alloy, ferromagnetic shape memory alloy, magnetorheological fluid, magnetorheological elastomer, electrorheological fluid, electrorheological elastomer, electroactive polymer, a piezoelectric material, a composite comprising at least one of the foregoing active materials with a non-active material, or a combination comprising at least one of the foregoing.

4. The mirror assembly of claim 1, wherein the activation signal comprises a thermal activation signal, a magnetic activation signal, an electrical activation signal, a mechanical activation signal, a pneumatic activation signal, or a combination comprising at least one of the foregoing activation signals.

5. The mirror assembly of claim 1, further comprising a sensor in operative communication with the controller, wherein the sensor is configured to provide information to the controller for selectively applying the activation signal to the active material.

6. The mirror assembly of claim 1, wherein the mirror assembly is a motor vehicle rear view mirror assembly or side view mirror assembly.

7. A mirror assembly, comprising:
a reflective surface disposed on a substrate, wherein the substrate comprises an active material; and
a controller in operative communication with the active material, wherein the controller is operable to selectively apply an activation signal to the active material and effect a change in a property of the active material, wherein the change in the property results in a shape change of the substrate from a first shape to a second shape.

8. The mirror assembly of claim 7, wherein the active material comprises a shape memory alloy, ferromagnetic shape memory alloy, magnetorheological elastomer, electrorheological elastomer, electroactive polymer, a piezoelectric material, a composite comprising at least one of the foregoing active materials with a non-active material, or a combination comprising at least one of the foregoing.

9. The mirror assembly of claim 7, wherein the activation signal comprises a thermal activation signal, a magnetic activation signal, an electrical activation signal, a mechanical activation signal, a pneumatic activation signal, or a combination comprising at least one of the foregoing activation signals.

10. The mirror assembly of claim 7, further comprising a sensor in operative communication with the controller, wherein the sensor is configured to provide information to the controller for selectively applying the activation signal to the active material.

11. The mirror assembly of claim 7, further comprising an actuator in operative communication with at least a portion of the substrate and the controller, wherein the actuator comprises an active material.

12. The mirror assembly of claim 1, wherein the mirror assembly is a motor vehicle rear view mirror assembly or side view mirror assembly.

13. A method, comprising:
providing a reflective surface in a first position and/or a first shape;
applying an activation signal to an active material and causing a change in a property of the active material, wherein the active material is in operative communication with at least a portion of a substrate onto which the reflective surface is disposed; and
changing a position and/or shape of the reflective surface by the change in the property of the active material effective to move the reflective surface from the first position and/or first shape to a selected second position and/or second shape.

14. The method of claim 13, further comprising returning the position and/or shape of the reflective surface to the first position and/or first shape by discontinuing the activation signal to the active material.

15. The method of claim 13, wherein the active material comprises a shape memory alloy, ferromagnetic shape memory alloy, magnetorheological fluid, magnetorheological elastomer, electrorheological fluid, electrorheological elastomer, electroactive polymer, a piezoelectric material, a composite comprising at least one of the foregoing active materials with a non-active material, or a combination comprising at least one of the foregoing.

16. The method of claim 13, wherein the activation signal comprises a thermal activation signal, a magnetic activation signal, an electrical activation signal, a mechanical activation signal, a pneumatic activation signal, or a combination comprising at least one of the foregoing activation signals.
